(19) United States
(12) Patent Application Publication
(10) Pub. No.: US 2007/0230216 A1
(43) Pub. Date: Oct. 4, 2007

(54) Prismatic light-guide plate and illumination device that enable the provision of good-quality planar light source

(75) Inventors: Yasuhiro Ite, Kawasaki (JP); Chikara Nishio, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/516,604

(22) Filed: Sep. 7, 2006

(30) Foreign Application Priority Data
Mar. 30, 2006 (JP) 2006-93413

(51) Int. Cl. F21V 7/04

(52) U.S. Cl. 362/620; 362/607; 362/606; 362/617

(57) ABSTRACT

A prismatic light-guide plate has a prismatic surface, which is provided with a plurality of prisms that reflect light that is incident from a light-incident end thereof, and an emission surface opposite to the prismatic surface, which completely reflects the light that is incident thereto to propagate the same, and which also emits emitted light that is reflected from the prisms. The prismatic light-guide plate has scattering portions provided in a region of the emission surface that emits the emitted light at a high density, for scattering the emitted light and broadening an angle of view of light.

### CROSS REFERENCE TO RELATED APPLICATION

This application is based upon and claims the benefit of priority from, the prior Japanese Patent Application No. 2006-093413, filed on Mar. 30, 2006, the entire contents of which are incorporated herein by reference.

### BACKGROUND OF THE INVENTION

1. Field of the Invention

The present invention relates to a prismatic light-guide plate and an illumination device and, in particular, to a prismatic light-guide plate and an illumination device that can be used in a liquid-crystal display device for a mobile phone or digital camera.

2. Description of the Related Art

The display portion of a liquid-crystal display device that is used in many appliances of the prior art, such a mobile phones, digital cameras, and personal computers (PCs), is formed of a liquid-crystal panel and a planar light source unit.

Since a liquid-crystal panel does not have any light-emitting capability, the liquid-crystal panel by itself is dark and it is usually difficult to distinguish an image thereon. For that reason, it is necessary for the liquid-crystal panel to have light transmitted or reflected thereto from an illumination device (planar light source unit), in order to make the image displayed on the liquid-crystal panel visible. In other words, there are two main types of planar light source unit: a backlight type of planar light source unit and a frontlight type of planar light source unit.

In the prior art, Japanese Unexamined Patent Publication (Kokai) No. 2005-293940 proposes a configuration having a light-guide plate of a composite material that comprises a resin having an alicyclic structure, which acts as a backlight device using an ideal light-guide plate such as one with a high transcription ratio, little variation in quality, and a high brightness, and which has a raised dot pattern on a light-emitting surface thereof. A reflective sheet is stacked on a light-reflecting surface of the light-guide plate, which has a plurality of protruberant portions of a base diameter of 1 μm to 50 μm and a height of 0.5 μm to 30 μm, and a downward-facing prism sheet and a light-scattering sheet are stacked onto the light-emitting surface thereof.

Another prior-art configuration proposed in Japanese Unexamined Patent Publication (Kokai) No. 2005-209558 is used as a backlight device provided with a very bright light-guide plate, which does not have a dot-like appearance, and a downward-facing prism sheet. A reflective sheet is stacked onto a light-reflecting surface of the light-guide plate formed of a thermoplastic resin, which is provided with protruberant portions with an average base area of 0.8 μm2 to 78 μm2 and an average height of at least 0.5 μm but less than 5 μm or depressions of an average aperture portion area of 0.8 μm2 to 78 μm2 and an average depth of at least 0.5 μm but less than 5 μm, on a light-emitting surface of the light-guide plate, and a downward-facing prism sheet and scattering sheet are stacked onto the light-emitting surface thereof.

In a further prior-art configuration proposed in Japanese Unexamined Patent Publication (Kokai) No. 2004-127622, which is used as an illumination device in which the thickness of the display portion has been reduced while it can be used in dark places, light from a light source is incident internally from a side edge surface, light that propagates therein is emitted from an emission surface by a light-guide plate, emission surfaces are formed on both the front and rear surfaces of the light-guide plate, and prism portions are formed on both emission surfaces to cause propagated light from within the light-guide plate to be reflected and emitted from the emission surface on the front surface side and the emission surface on the rear surface side.

The prior art and its associated problems will be described later with reference to the accompanying drawings.

### SUMMARY OF THE INVENTION

An objective of the present invention is to provide a prismatic light-guide plate, an illumination device, and an electronic device that enable the provision of a good-quality planar light source that has little deterioration in brightness even if the position thereof is displaced with respect to the display panel.

According to the present invention, there is provided a prismatic light-guide plate having a prismatic surface, which is provided with a plurality of prisms that reflect light that is incident from a light-incident end thereof, and an emission surface opposite to the prismatic surface, which completely reflects the light that is incident thereto to propagate the same, and which also emits emitted light that is reflected from the prisms, comprising scattering portions provided in a region of the emission surface that emits the emitted light at a high density, for scattering the emitted light and broadening an angle of view of light.

The prisms may be formed in bands at a predetermined spacing on the prismatic surface. The scattering portions may be provided to correspond to the predetermined spacing at which the prisms are provided. The scattering portions may be provided in correspondence with aperture portions of a black matrix of a display unit. The scattering portions may be formed to include at least one aperture portion of the black matrix of the display unit.

Each of the scattering portions may comprise a convex prism shape, a convex cone shape, a concave prismatic groove shape, a concave cone shape, or a flattened ridge portion. Each of the scattering portions may comprise a shape where a light-incident end side of the prismatic light-guide plate is small and a non-light-incident end side thereof is large. Each of the scattering portions may comprise a distribution density where a light-incident end side of the prismatic light-guide plate is low density and a non-light-incident end side thereof is high density.

The scattering portions may be formed integrally with the prismatic light-guide plate. The scattering portions may be formed on a scattering portion formation sheet that is separate from the prismatic light-guide plate, and the scattering portion formation sheet may be integrated with the prismatic light-guide plate by attachment to the prismatic light-guide plate.

Further, according to the present invention, there is provided an illumination device including a light source and a prismatic light-guide plate, wherein the prismatic light-guide plate has a prismatic surface, which is provided with a plurality of prisms that reflect light that is incident from a light-incident end thereof, and an emission surface opposite to the prismatic surface, which completely reflects the light that is incident thereto to propagate the same, and which also emits emitted light that is reflected from the prisms, wherein the prismatic light-guide plate comprises scattering portions provided in a region of the emission surface that emits the emitted light at a high density, for scattering the emitted light and broadening an angle of view of light.

The illumination device may further comprise a light-conducting member that converts light from the light source that is a point light source into a linear beam of light, and supplies the same to the prismatic light-guide plate.

In addition, according to the present invention, there is also provided an electronic device comprising an illumination device including a light source and a prismatic light-guide plate, wherein the prismatic light-guide plate has a prismatic surface, which is provided with a plurality of prisms that reflect light that is incident from a light-incident end thereof, and an emission surface opposite to the prismatic surface, which completely reflects the light that is incident thereto to propagate the same, and which also emits emitted light that is reflected from the prisms, wherein the prismatic light-guide plate comprises scattering portions provided in a region of the emission surface that emits the emitted light at a high density, for scattering the emitted light and broadening an angle of view of light.

The illumination device may be provided with a first illumination device provided on one display surface of the display panel and a second illumination device provided on another display surface of the display panel; and an image on the one display surface may be displayed by light emitted from the second illumination device and also an image on the other display surface may be displayed by light emitted from the first illumination device.

The display panel may be a transmissive liquid-crystal display panel. The electronic device may be a clamshell-type mobile phone and the configuration is such that images displayed on the display panel are displayed by switching the first and second illumination devices for display on either the front or back of a movable side portion.

### BRIEF DESCRIPTION OF THE DRAWINGS

The present invention will be more clearly understood from the description of the preferred embodiments as set forth below with reference to the accompanying drawings, wherein:

FIG. 1 is a schematic perspective view of an example of an illumination device to which the present invention is applied;

FIG. 2 is a schematic perspective view of another example of an illumination device to which the present invention is applied;

FIG. 3 is a schematic perspective view of a further example of an illumination device to which the present invention is applied;

FIG. 4 is schematically illustrative of the propagation of light in a prismatic light-guide plate;

FIG. 5 is schematically illustrative of the convergence of light in the prismatic light-guide plate;

FIG. 6 is illustrative of the propagation positions and field-of-view characteristics of emitted light of the prismatic light-guide plate;

FIG. 7 shows light-emitting areas of the prismatic light-guide plate in detail;

FIG. 8 shows the emission of light from the prismatic light-guide plate;

FIG. 9 is an enlarged view of an example of a liquid-crystal panel;

FIG. 10 is illustrative of emitted light from a display device (liquid-crystal module) that uses the prismatic light-guide plate;

FIG. 11 is illustrative of emitted light when the prismatic light-guide plate and the liquid-crystal module are in a suitable positional relationship;

FIG. 12 is illustrative of emitted light when the prismatic light-guide plate and the liquid-crystal module are not in a suitable positional relationship;

FIG. 13 is illustrative of a first embodying example of a prismatic light-guide plate in accordance with the present invention;

FIG. 14 is illustrative of an example of a prior-art prismatic light-guide plate corresponding to FIG. 13;

FIGS. 15A and 15B are perspective views of the entire scattering portion of a first embodying example of the prismatic light-guide plate in accordance with the present invention;

FIG. 16 is a schematic view of a second embodying example of a prismatic light-guide plate in accordance with the present invention;

FIG. 17 is a schematic view of a third embodying example of a prismatic light-guide plate in accordance with the present invention;

FIG. 18 is a schematic view of a fourth embodying example of a prismatic light-guide plate in accordance with the present invention;

FIGS. 19A and 19B are perspective views of the entire scattering portion of the fourth embodying example of the prismatic light-guide plate in accordance with the present invention;

FIG. 20 is a schematic perspective view of a fifth embodying example of a prismatic light-guide plate in accordance with the present invention;

FIG. 21 is a schematic perspective view of a sixth embodying example of a prismatic light-guide plate in accordance with the present invention;

FIG. 22 is a schematic perspective view of a seventh embodying example of a prismatic light-guide plate in accordance with the present invention;

FIG. 23 is a schematic perspective view of a eighth embodying example of a prismatic light-guide plate in accordance with the present invention;

FIG. 24 is schematically illustrative of an embodying example of an illumination device in accordance with the present invention;

FIG. 25 is illustrative of scattering portions in the illumination device of FIG. 24;

FIG. 26 is schematically illustrative of light scattering by a prismatic light-guide plate in accordance with the present invention;

FIG. 27 illustrates the theory of light scattering by a prismatic light-guide plate in accordance with the present invention;

FIG. 28 is illustrative of simulation models of prismatic light-guide plates in accordance with the present invention;

FIG. 29 shows simulation results of the output of luminosity distribution and emission angle obtained by the simulation models shown in FIG. 28;

FIG. 30 shows further simulation results of the output of luminosity distribution and emission angle obtained by the simulation models shown in FIG. 28;

FIG. 31 is schematically illustrative of a ninth embodying example of a prismatic light-guide plate in accordance with the present invention;

FIG. 32 is an enlargement of a scattering portion for the prismatic light-guide plate shown in FIG. 31;

FIG. 33 is a schematic perspective view of a mobile phone that is an example of an electronic device to which the present invention can be applied; and

FIG. 34 schematically shows the outer surface of the movable side of the mobile phone of FIG. 33.

### DESCRIPTION OF THE PREFERRED EMBODIMENTS

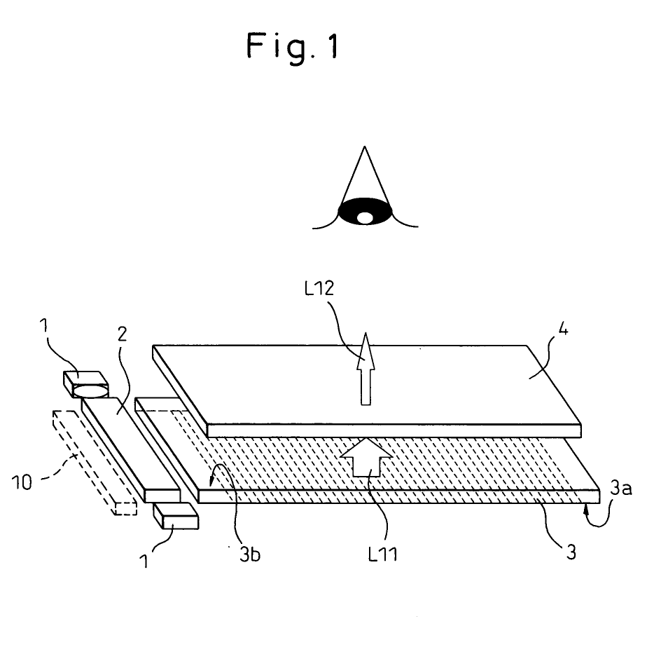

Before describing the embodiments of the present invention in detail, the description first concerns prior-art prismatic light-guide plates and illumination devices, together with problems therewith, with reference to FIGS. 1 to 12.

As previously stated, the display portion of a liquid-crystal display device that is used in many appliances of the prior art, such a mobile phones, digital cameras, and personal computers, is formed of a liquid-crystal panel and a planar light source unit. There are two main types of planar light source unit: a backlight type of planar light source unit and a frontlight type of planar light source unit.

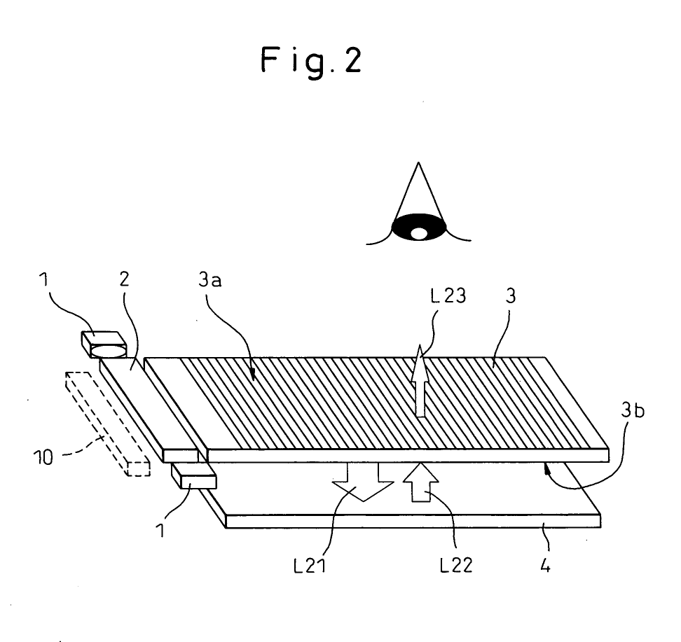

A perspective view of a backlight type of planar light source unit that is an example of an illumination device to which the present invention is applied is shown schematically in FIG. 1, and a perspective view of a frontlight type of planar light source unit that is another example of an illumination device to which the present invention is applied is shown schematically in FIG. 2. In FIGS. 1 and 2, reference number 1 denotes a point light source, 2 denotes a light-conducting member, 3 denotes a light-guide plate (a prismatic light-guide plate), 4 denotes a transmissive liquid-crystal panel, and 4′ denotes a reflective liquid-crystal panel 4′.

As shown in FIG. 1, the illumination device (planar light source unit) that is most often used is a backlit type of device which is provided with point light sources 1 such as light-emitting diodes, the light-conducting member 2 that converts the light from the point light source into a linear beam of light, and the prismatic light-guide plate 3 that converts the linear beam of light that was converted by the light-conducting member 2 into a planar sheet of light. In this case, the prismatic light-guide plate 3 is formed as a prismatic surface 3a on which is formed a plurality of prisms, on the lower side in FIG. 1, and also an emission surface 3b that is provided with a mirror surface that totally reflects and propagates the linear beam of light from the light-conducting member 2, on the upper side of FIG. 1.

With a backlight type of planar light source unit, emitted light L11 from the prismatic light-guide plate 3 disposed on the rear surface of the transmissive liquid-crystal panel 4 (the lower side in FIG. 1) shines from the rear surface of the transmissive liquid-crystal panel 4, and the user observes transmitted light L12 that has passed through the transmissive liquid-crystal panel 4 to the surface (the upper side in FIG. 1) to make visible an image that is displayed on the transmissive liquid-crystal panel 4. Note that a linear light source 10 could be used instead of the point light sources 1, as shown in FIG. 1.

A frontlight type of planar light source unit has basically the same structure as that of the backlight type of planar light source unit, as shown in FIG. 2, except that the frontlight type of planar light source unit is disposed on the surface (the upper side in FIG. 2) of the reflective liquid-crystal panel 4′. In this case, the prismatic surface 3a of the prismatic light-guide plate 3 is on the upper side in FIG. 2 and the emission surface 3b is on the lower side thereof.

Emitted light L21 from the prismatic light-guide plate 3 shines from the surface of the reflective liquid-crystal panel 4′. The user observes transmitted light L23 that is reflected light L22 that has been reflected by the reflective liquid-crystal panel 4′ (the rear surface of the reflective liquid-crystal panel 4′) and transmitted through the prismatic light-guide plate 3, to make visible an image displayed on the reflective liquid-crystal panel 4′.

A mobile phone that is a typical example of an electronic device is now usually provided with a built-in camera. There are two main photographic situations: one in which the photographer captures another subject and one in which the photographer takes a self-portrait. To suit both situations, the clamshell-type mobile phone is provided with a camera that can be rotated to either the front or back and a display panel that can be similarly rotated, or display panels are provided on both the front and rear surfaces of the movable side, by way of example.

With a clamshell-type mobile phone having display panels on both the front and rear surfaces of the movable side, the basic structure of the display portion is generally such that a backlight unit and a liquid-crystal panel module are assembled back-to-back, but it has been proposed to use a single high-priced liquid-crystal panel provided with planar light source unit on both surfaces thereof.

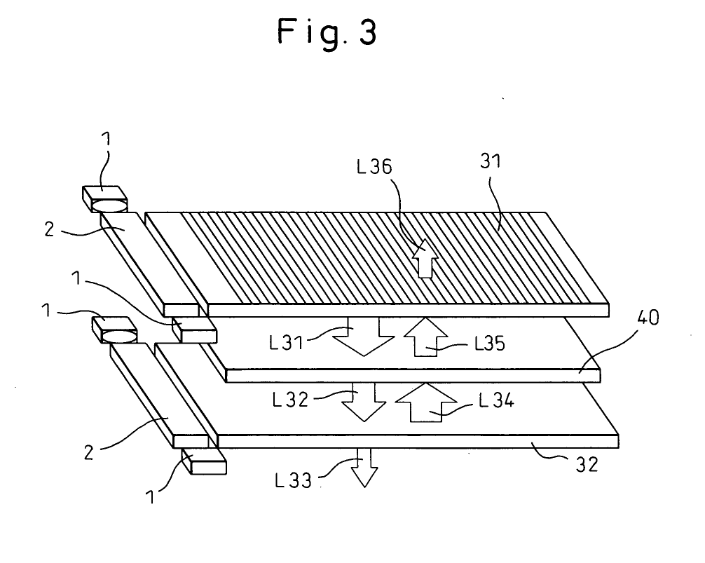

A perspective view of a further example of an illumination device to which the present invention is applied is shown in FIG. 3, illustrating a proposal in which frontlight-type planar light source units (prismatic light-guide plates 31 and 32) are disposed on both the front and rear surfaces of one liquid-crystal panel 40 so that both the front and the rear of the high-priced liquid-crystal panel 40 can be observed.

In other words, when the image displayed on the transmissive liquid-crystal panel 40 is to be observed from the lower side of FIG. 3, emitted light L31 from the first frontlight type of planar light source unit (the first prismatic light-guide plate 31) that is disposed on the surface of the transmissive liquid-crystal panel 40 (on the upper side in FIG. 3) shines from the surface of the transmissive liquid-crystal panel 40. Transmitted light L32 that has passed through the transmissive liquid-crystal panel 40 passes through the second frontlight type of planar light source unit (the prismatic light-guide plate 32) and the user observes transmitted light L33 that has passed through this second prismatic light-guide plate 32 from the rear surface (the lower side in FIG. 3), to make visible the image displayed on the transmissive liquid-crystal panel 40.

When the image displayed on the transmissive liquid-crystal panel 40 is to be observed from the upper side in FIG. 3, emitted light L34 from the second prismatic light-guide plate 32 disposed on the rear surface of the transmissive liquid-crystal panel 40 shines from the rear surface of the transmissive liquid-crystal panel 40. Transmitted light L35 that has passed through the transmissive liquid-crystal panel 40 passes through the first prismatic light-guide plate 31 and the user observes transmitted light L36 that has passed through this first prismatic light-guide plate 31 from the front surface thereof, to make visible the image displayed on the transmissive liquid-crystal panel 40.

With a structure such as this, in which a liquid-crystal panel is sandwiched between frontlight-type planar light source units or a single frontlight-type planar light source unit is employed as a backlight type of unit, a problem arises in that the optical strength (brightness) deteriorates because of the prismatic light-guide plates 31 and 32.

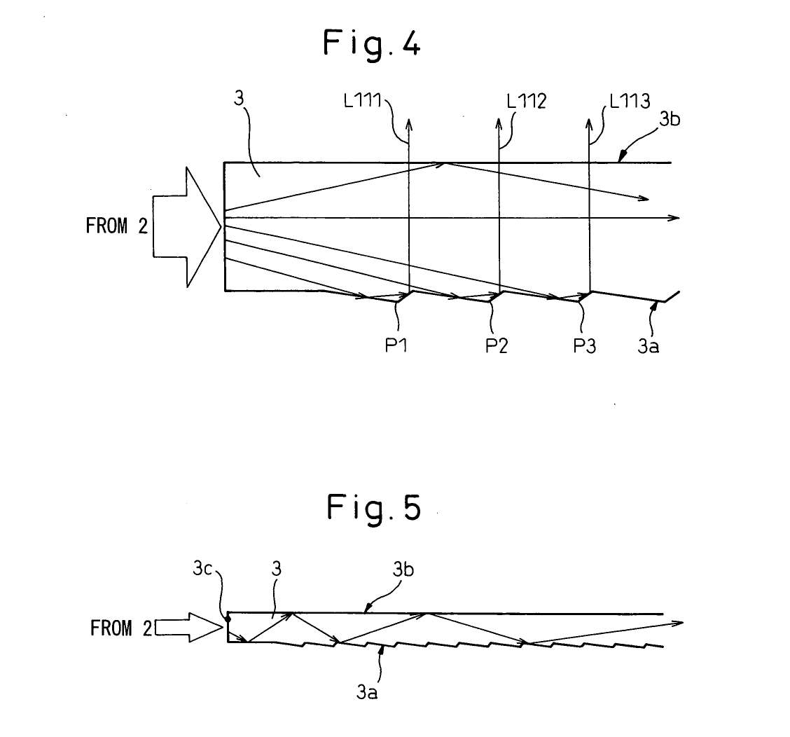

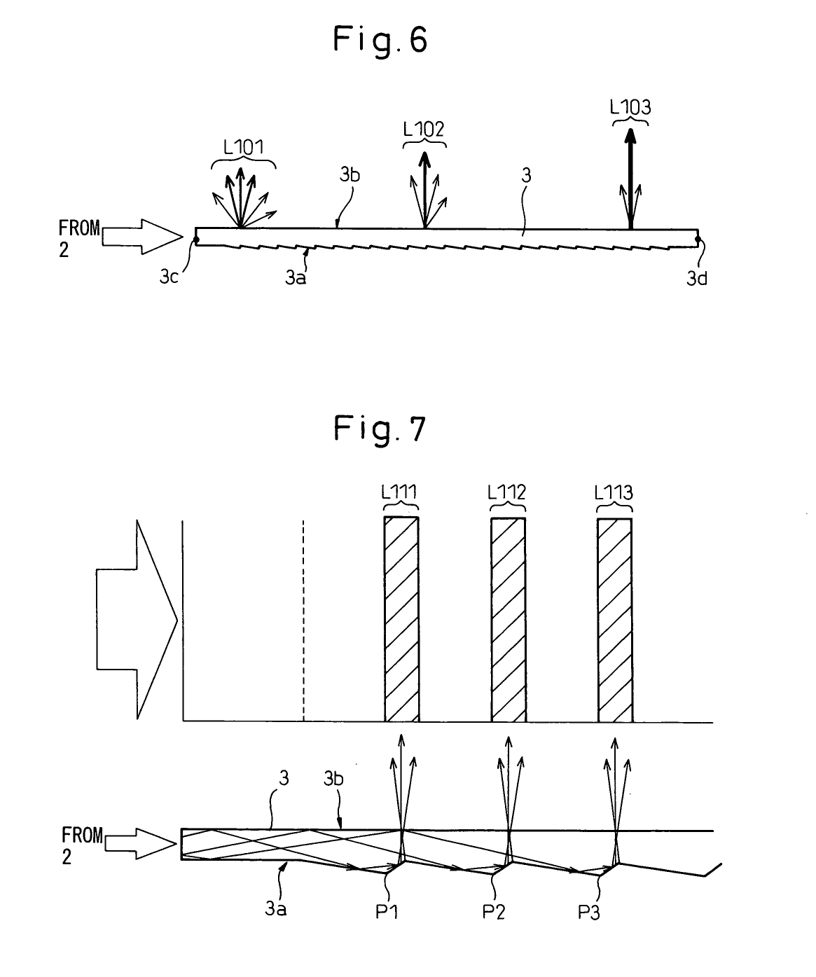

The propagation of light through a prismatic light-guide plate is shown schematically in FIG. 4, the convergence of light in a prismatic light-guide plate is shown schematically in FIG. 5, and the propagation positions and field-of-view characteristics of emitted light of the prismatic light-guide plate are shown for illustration in FIG. 6.

As shown in FIG. 4 by way of example, the prismatic light-guide plate 3 used as a frontlight type of planar light source unit is required to be thin on the one hand, so the shape thereof is generally a thin plate, since it must have the function of emitting light in a plane. Light from the light-conducting member 2 (the light sources 1) is reflected totally by the mirror surface (the emission surface 3b) within the prismatic light-guide plate 3 and propagates, then is reflected in turn by each of prisms P1, P2, P3, etc., and is emitted from the emission surface 3b as corresponding bits of emitted light L111, L112, L113, etc.

As shown in FIG. 5, the characteristic of the thus-propagated light is such that the direction of propagation of the light converges in the direction parallel to the emission surface 3b as it propagates within the prismatic light-guide plate 3, in other words, as it moves further to the right from a light-incident end 3c in FIG. 5.

For that reason, the propagated light becomes emitted light L101 that has a wide (broad) field-of-view characteristic in the region close to the light-incident end 3c, because it has not yet converged towards the direction parallel to the emission surface 3b, whereas the propagated light becomes emitted light L103 that has a narrow (“peaky”) characteristic in the region close to a non-light-incident end 3d opposite to the light-incident end 3c of the prismatic light-guide plate 3, because it has converged towards the direction parallel to the emission surface 3b. Note that emitted light L102 in the region between the light-incident end 3c and the non-light-incident end 3d of the prismatic light-guide plate 3 has a field-of-view characteristic that is intermediate between the broad emitted light L101 and the “peaky” emitted light L103.

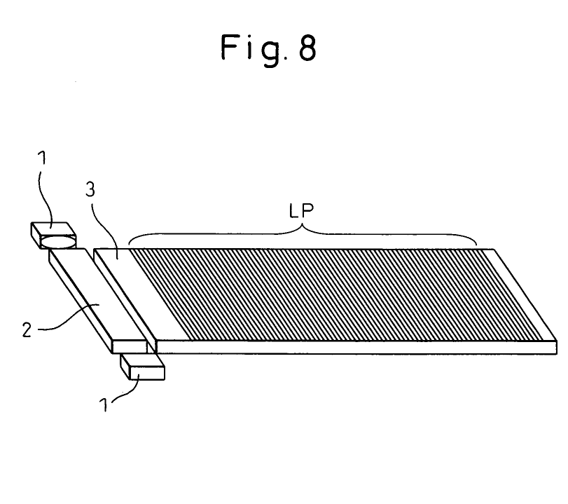

Light-emitting areas of the prismatic light-guide plate are shown in detail in FIG. 7 and the emission of light from the prismatic light-guide plate is shown in FIG. 8.

As shown in FIG. 7, the light emitted from the prismatic light-guide plate 3 is not emitted in a uniform distribution from the entire emission surface 3b. Strictly speaking, the propagated light is reflected by each of the prisms P1, P2, P3, etc., and is emitted as stripes (bands) of emitted light L111, L112, L113, etc., at a fine spacing from the emission surface 3b of the prismatic light-guide plate 3. As shown in FIG. 8, a pseudo-planar sheet of light LP is formed from the densely packed, finely spaced bands of emitted light (L111, L112, L113, etc.).

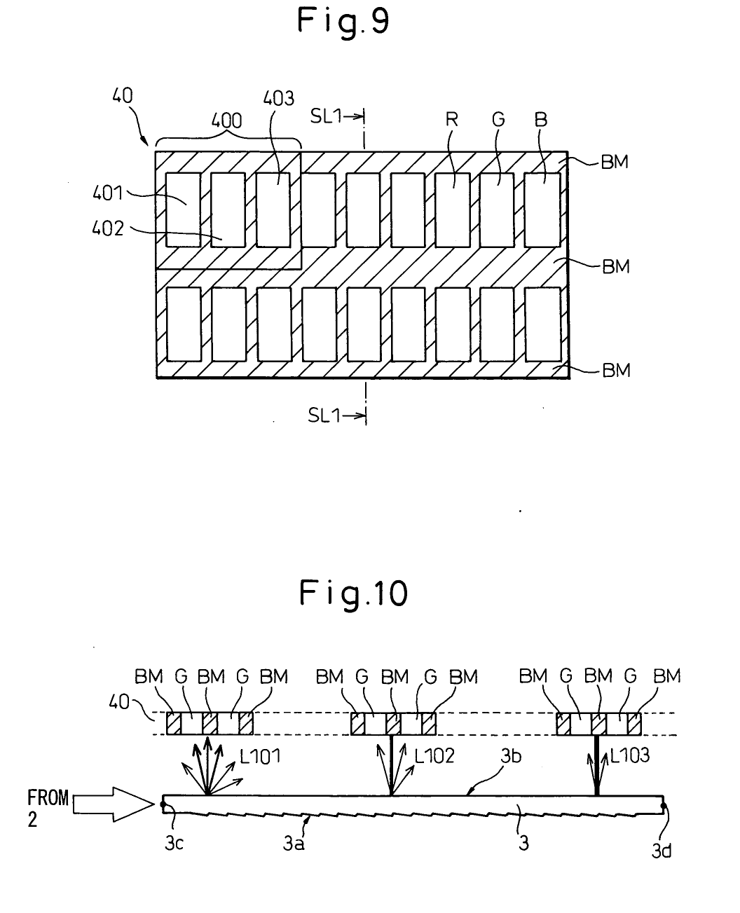

An example of a liquid-crystal panel is shown enlarged in FIG. 9. If a liquid-crystal panel (such as the transmissive liquid-crystal panel 40) is observed enlarged to the level of pixels 400, as shown in FIG. 9, each pixel 400 consists of a liquid-crystal portion (sub-pixel) 401 for red, a liquid-crystal portion 402 for green, and a liquid-crystal portion 403 for blue, having red (R), green (G), and blue (B) color filters, and a black matrix BM that surrounds these liquid-crystal portions 401 to 403.

FIG. 10 is illustrative of emitted light from a display device (liquid-crystal module) in which a prismatic light-guide plate is used, being a section taken along the line SL1-SL1 of FIG. 9. In this case, the liquid-crystal module shown in FIG. 10 consists of the liquid-crystal panel (40) and the prismatic light-guide plate 3 (planar light source unit) shown in FIG. 9, but FIG. 10 is drawn to focus on the color filters G corresponding to the green (G) liquid-crystal portions 402, and the black matrix BM therearound.

When planar white light from the prismatic light-guide plate 3 passes through each color filter in the liquid-crystal module, it becomes colored light corresponding to that color filter and can be seen as a color image. However, the amount of light that is transmitted therethrough varies with the aperture ratio of the black matrix BM surrounding the color filter.

In other words, the position of the black matrix BM has a large effect on the amount of transmitted light in the range between the light-incident end 3c side of the prismatic light-guide plate 3 and the non-light-incident end 3d side thereof, with the effect being greatest towards the non-light-incident end 3d side thereof. This is because the field-of-view characteristic of the emitted light becomes narrower and “peaky” towards the non-light-incident end 3d side of the light-guide plate (see the emitted light L103 in FIG. 6), so that if the black matrix BM part of the liquid-crystal panel covers a band-shaped emission area, the light there is blocked and thus the amount of transmitted light drops dramatically there.

In contrast thereto, the field-of-view characteristic of the emitted light is broader on the light-incident end 3c side (see the emitted light L101 in FIG. 6) so that light is emitted not only perpendicular to the emission surface but also at an angle thereto to a certain degree. This means that the black matrix BM does not cover the emission area so that all of the emitted light is blocked, and thus a large amount of emitted light is incident on each color filter G from an angle so the drop in the amount of transmitted light is comparatively small. A particular problem that arises when considering the assembly of a flat panel display is the non-light-incident end 3d.

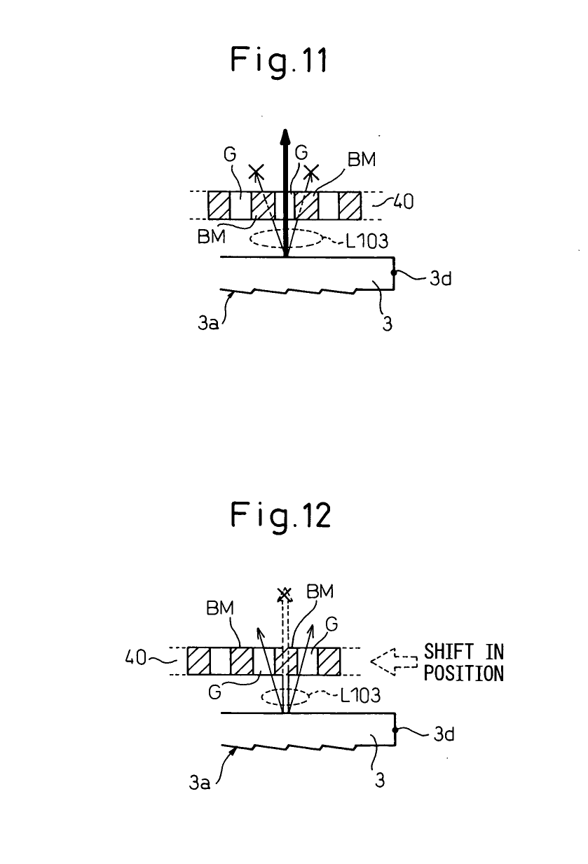

FIG. 11 is illustrative of emitted light when the prismatic light-guide plate and the liquid-crystal module are in a suitable positional relationship, and FIG. 12 is illustrative of emitted light when the prismatic light-guide plate and the liquid-crystal module are not in a suitable positional relationship.

When each aperture portion of the black matrix BM (the color filter G) is in a suitable positional relationship with the light emitted at the fine spacing from the prismatic light-guide plate (planar light source unit), as shown in FIG. 11, it is possible to ensure a sufficient amount of transmitted light even at locations corresponding to the “peaky” emitted light L103 at the non-light-incident end 3d end of the prismatic light-guide plate 3, by way of example.

However, if an aperture portion of the black matrix BM (the color filter G) is not in a suitable positional relationship with the light emitted at the fine spacing from the prismatic light-guide plate (planar light source unit), in other words, if the black matrix BM part of the liquid-crystal panel is shifted in position so as to cover the band-shaped emission area, as shown in FIG. 12, the light will be substantially blocked by the black matrix BM, particularly the “peaky” emitted light L103 at the non-light-incident end 3d end of the prismatic light-guide plate 3, making it difficult to ensure a sufficient amount of transmitted light (brightness).

Thus, if the position of each aperture portion of the black matrix BM (the color filter G) and the position of the light emitted at a fine spacing from the prismatic light-guide plate 3 (i.e., the position of each prism of the prismatic surface 3a of the prismatic light-guide plate 3) are in an unsuitable positional relationship, in other words, if a shift in the positioning makes the black matrix BM part of the liquid-crystal panel cover the position at which light is emitted in finely-spaced bands, the amount of light (brightness) transmitted through the color filter G will be greatly different between the light-incident end 3c of the prismatic light-guide plate 3 and the non-light-incident end 3d thereof, making it impossible to ensure a stable brightness spectrum (uniform brightness within the surface).

Therefore, to ensure highly accurate positioning of the planar light source unit and the liquid-crystal panel during the assembly of the liquid-crystal module, it is necessary to invest comparatively heavily in equipment for positional adjustment and assembly, using means such as a CCD camera, or it is necessary to further reduces variations in component dimensions.

Embodying examples of a prismatic light-guide plate, an illumination device, and an electronic device in accordance with the present invention are described in detail below with reference to the accompanying drawings.

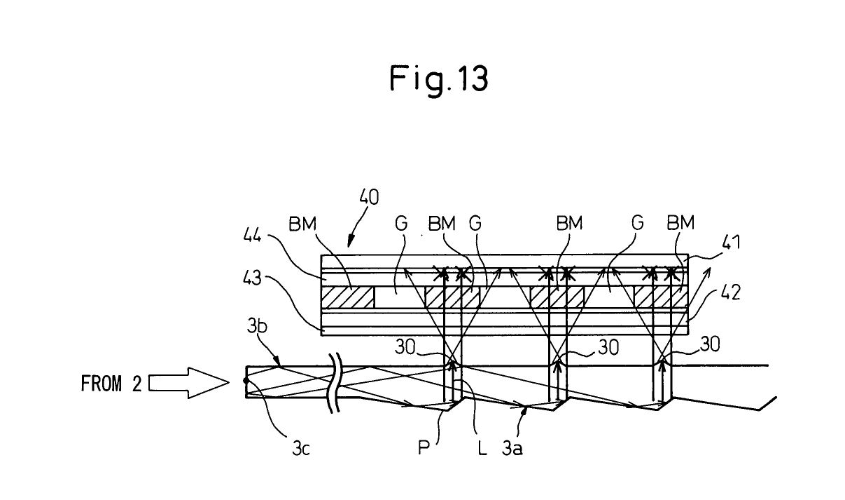

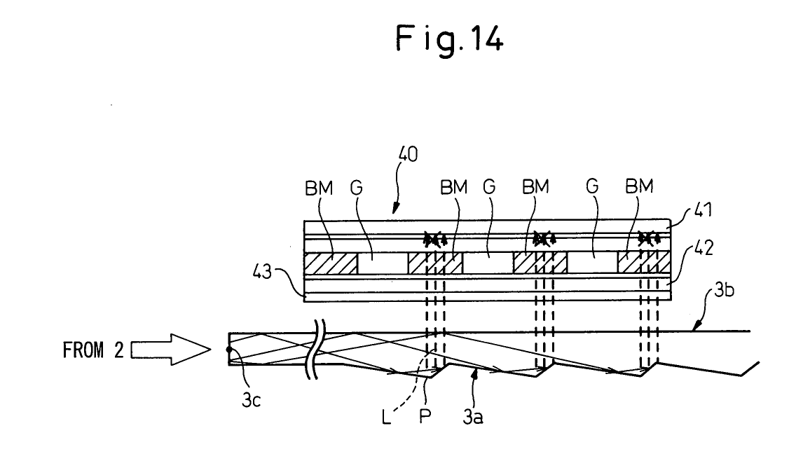

A first embodying example of a prismatic light-guide plate in accordance with the present invention is shown in FIG. 13 and an example of a prior-art prismatic light-guide plate corresponding to that of FIG. 13 is shown in FIG. 14. In FIGS. 13 and 14, reference number 3 denotes a prismatic light-guide plate, 3a denotes a prismatic surface, 3b denotes an emission surface, 3c denotes a light-incident end, 30 denotes scattering portions, 40 denotes a liquid-crystal panel (LCD), 41 and 42 denote glass substrates, 43 denotes a polarizing plate, 44 denotes a liquid crystal, G denotes green color filters, and BM denotes a black matrix.

With this first embodying example, scattering portions 30 are provided on the emission surface 3b of the prismatic light-guide plate 3, as shown in FIG. 13. The scattering portions 30 are provided in regions of the emission surface 3b of the prismatic light-guide plate 3 where emitted light that has been reflected by prisms P provided on the prismatic surface 3a of the prismatic light-guide plate 3 is emitted at a high density, with the configuration being such that the emitted light L is scattered by these scattering portions 30 so that the angle of view of the light becomes broader.

In other words, light from the light source (the light-conducting member 2) is incident perpendicularly from the light-incident surface at the light-incident end 3c, is propagated in the direction of the arrows within the prismatic light-guide plate 3, is reflected by each of prisms P provided in the prismatic surface 3a, and is directed towards the emission surface 3b. The emitted light L that has been directed towards the emission surface 3b is scattered by the scattering portions 30 provided on the emission surface 3b. This makes it possible to ensure a sufficient amount of transmitted light by making the emitted light (scattered emitted light) shines through the aperture portions of the black matrix BM (the color filters G), by scattering the emitted light by the scattering portions 30, even if the black matrix BM is positioned to block the emitted light that is reflected from the prisms P, by way of example.

With the prior-art prismatic light-guide plate 3 shown in FIG. 14, on the other hand, the scattering portions 30 are not provided on the emission surface 3b and thus the emitted light L that has been reflected by the prisms P and directed towards the emission surface 3b is blocked as is by the black matrix BM, as was described with reference to FIG. 12. Particularly at the non-light-incident end 3d side of the prismatic light-guide plate 3, the light is substantially blocked by the black matrix BM and thus the emitted light L does not shine sufficiently through the color filters G.

In this case, the scattering portions 30 have the function of causing light to scatter so that the emitted light can be made to seem broader in a state similar to that of emitted light in the vicinity of the light-incident end 3c. In addition, the scattering portions 30 on the emission surface 3b are formed only in the range in which the emitted light L that has been reflected by the prisms P is emitted, as shown in FIG. 13, so that when this assembly is used as a frontlight type of planar light source unit or the like, by way of example, there is no distortion of the display image even when an image transmitted by the prismatic light-guide plate 3 itself is viewed.

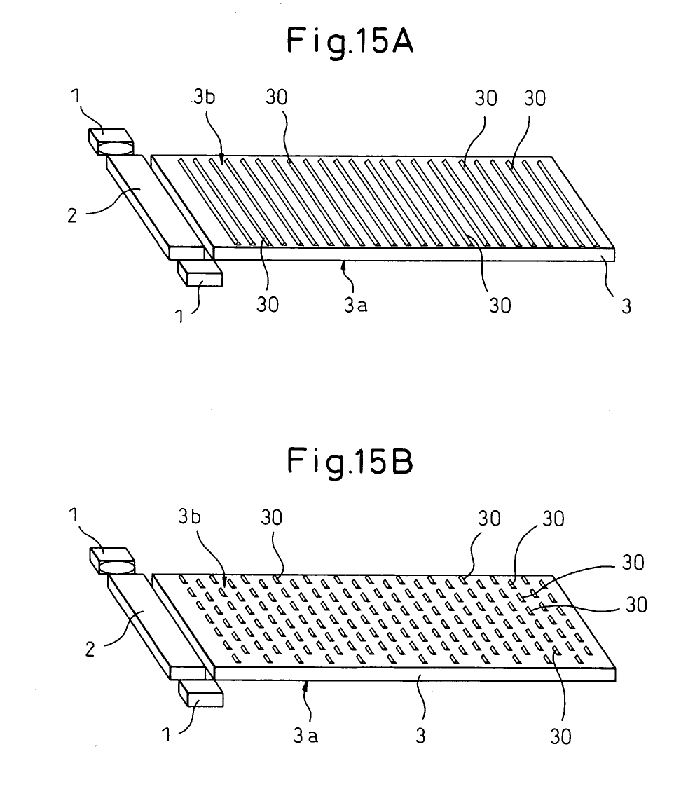

Perspective views of the entire scattering portion of a first embodying example of the prismatic light-guide plate in accordance with the present invention are shown in FIGS. 15A and 15B.

The scattering portions 30 could be formed continuously on the emission surface 3b of the prismatic light-guide plate 3 in a similar manner to the prisms P formed on the prismatic surface 3a, as shown in FIG. 15A, or they could be formed discontinuously on the emission surface 3b of the prismatic light-guide plate 3, as shown in FIG. 15B.

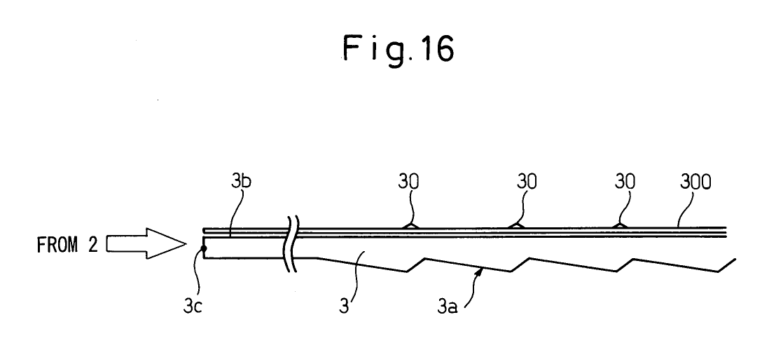

A second embodying example of a prismatic light-guide plate in accordance with the present invention is shown schematically in FIG. 16.

As shown in FIG. 16, the scattering portions 30 are not formed directly on the prismatic light-guide plate 3 of this second embodying example, but the configuration is such that a member (scattering portion formation sheet) 300 on which the scattering portions 30 have been formed previously is attached to the emission surface 3b of the prismatic light-guide plate 3 to integrate it therewith. Note that various methods could be used for attaching the prismatic light-guide plate 3 and the scattering portion formation sheet 300, such as gluing, fusing, or electrostatic adhesion.

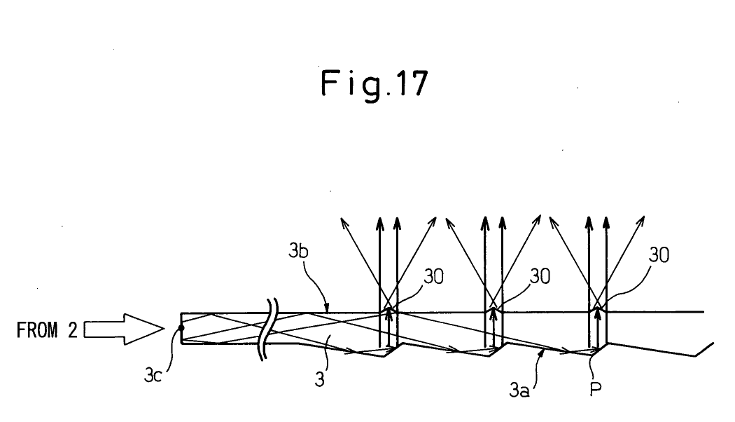

A third embodying example of a prismatic light-guide plate in accordance with the present invention is shown schematically in FIG. 17.

As shown in FIG. 17, the scattering portions 30 of the prismatic light-guide plate of this third embodying example are formed in a convex prism shape on the emission surface 3b of the prismatic light-guide plate 3. Note that the scattering portions 30 of the convex prism shape could be formed in continuous bands as shown in the previously described FIG. 15A, or discontinuously as shown in FIG. 15B.

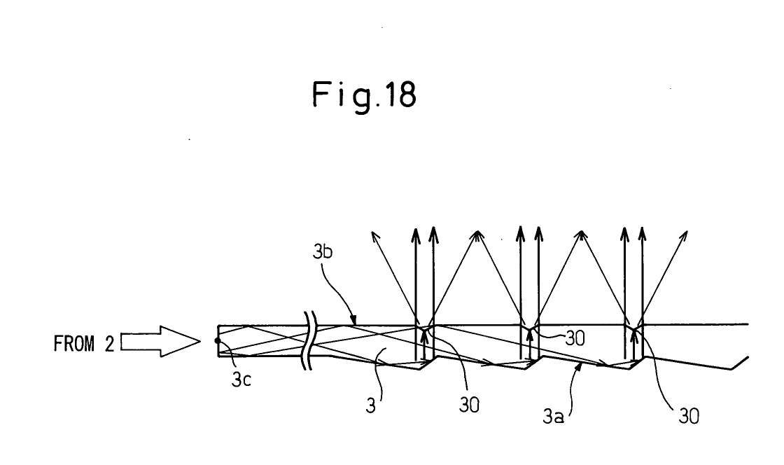

A fourth embodying example of a prismatic light-guide plate in accordance with the present invention is shown schematically in FIG. 18.

As shown in FIG. 18, the scattering portions 30 of the prismatic light-guide plate of this fourth embodying example are formed in a concave prismatic groove shape on the emission surface 3b of the prismatic light-guide plate 3.

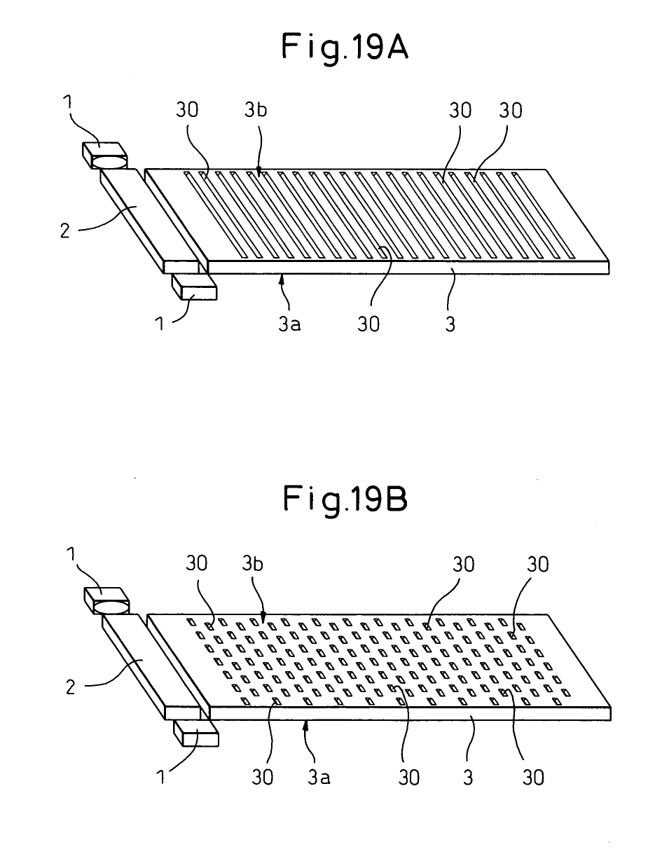

Perspective views of the entire scattering portions of the fourth embodying example of the prismatic light-guide plate in accordance with the present invention are shown in FIGS. 19A and 19B.

The scattering portions 30 of this concave prismatic groove shape could be formed continuously on the emission surface 3b of the prismatic light-guide plate 3 in a similar manner to the prisms P formed on the prismatic surface 3a, as shown in FIG. 19A, or they could be formed discontinuously on the emission surface 3b of the prismatic light-guide plate 3, as shown in FIG. 19B.

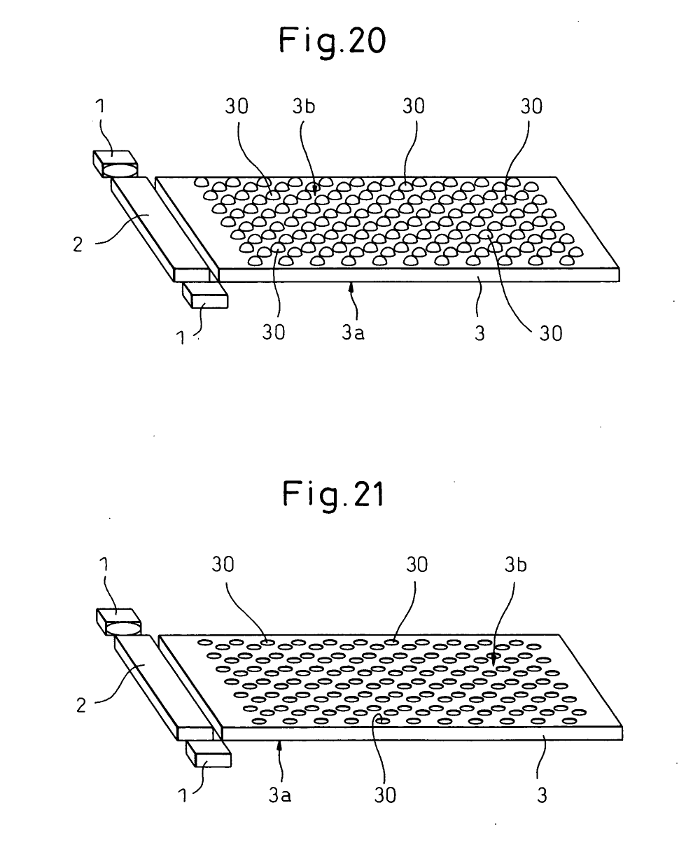

A schematic perspective view of a fifth embodying example of a prismatic light-guide plate in accordance with the present invention is shown in FIG. 20.

As shown in FIG. 20, the scattering portions 30 of the prismatic light-guide plate of this fifth embodying example are formed in a convex cone shape on the emission surface 3b of the prismatic light-guide plate 3. Forming the scattering portions 30 in a convex cone shape in this manner enables a wider scattering of the emitted light than with portions of a convex prism shape.

A schematic perspective view of a sixth embodying example of a prismatic light-guide plate in accordance with the present invention is shown in FIG. 21.

As shown in FIG. 21, the scattering portions 30 of the prismatic light-guide plate of this sixth embodying example are formed in a concave cone shape on the emission surface 3b of the prismatic light-guide plate 3. Forming the scattering portions 30 in a concave cone shape in this manner enables a wider scattering of the emitted light than with portions of a concave prismatic groove shape (concave prism shape), in a similar manner to those of the fifth embodying example shown in FIG. 20.

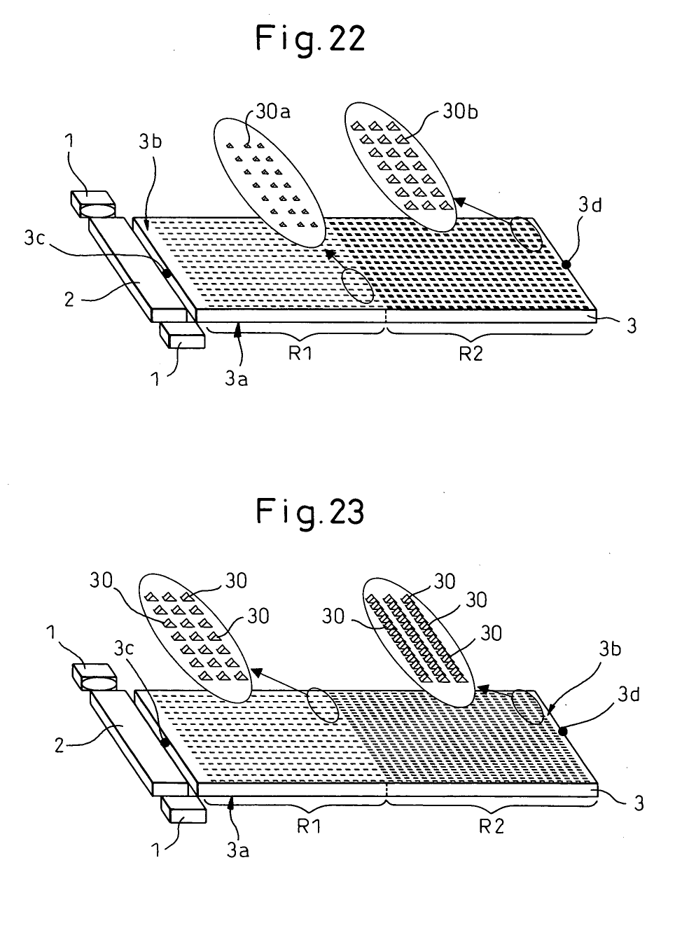

A schematic perspective view of a seventh embodying example of a prismatic light-guide plate in accordance with the present invention is shown in FIG. 22.

In the prismatic light-guide plate of this seventh embodying example, the shapes of the scattering portions formed on the emission surface 3b of the prismatic light-guide plate 3 could be varied to produce scattering portions 30a of a smaller shape at the light-incident end 3c side of that emission surface 3b (in a region R1) and also scattering portions 30b of a larger shape at the non-light-incident end 3d side thereof (in a region R2). In other words, since the region in which the angle of view of the emitted light becomes “peaky” is at the non-light-incident end 3d side of the prismatic light-guide plate 3, the scattering portions 30b are formed in a larger shape (large convex prism shape) therein, which has the effect of broadening the emitted light in the region R2 at the non-light-incident end 3d side.

Note that in the seventh embodying example shown in FIG. 22, the regions R1 and R2 are set by a boundary in the vicinity of the center of the prismatic light-guide plate 3 in the light-propagation direction thereof, where the scattering portions 30a of a small shape are formed in the region R1 and the scattering portions 30b of a large shape are formed in the region R2. However, the configuration could also be such that there are not two regions, but the scattering of light is made to increase with increasing distance from the light-incident end of the prismatic light-guide plate by means such as making the sizes of the scattering portions vary in multiple steps (in gradations) or by having a combination of continuous shapes and different shapes.

A schematic perspective view of an eighth embodying example of a prismatic light-guide plate in accordance with the present invention is shown in FIG. 23.

As shown in FIG. 23, the prismatic light-guide plate of this eighth embodying example is configured in such a manner that the distribution density of the scattering portions 30 formed on the emission surface 3b of the prismatic light-guide plate 3 is low in the light-incident end 3c side of that prismatic light-guide plate 3 (the region R1) and high in the non-light-incident end 3d side thereof (the region R2). In other words, since the region in which the angle of view of the emitted light becomes “peaky” is at the non-light-incident end 3d side of the prismatic light-guide plate 3, the scattering portions 30b are formed to be more numerous (densely packed) in the region R2 at the non-light-incident end 3d side.

Note that in the eighth embodying example shown in FIG. 23, the variation in distribution density of the scattering portions 30 could be done by varying the distribution density of the scattering portions in multiple steps, not just in the two regions R1 and R2, and the scattering portions could also be omitted at the light-incident end of the prismatic light-guide plate.

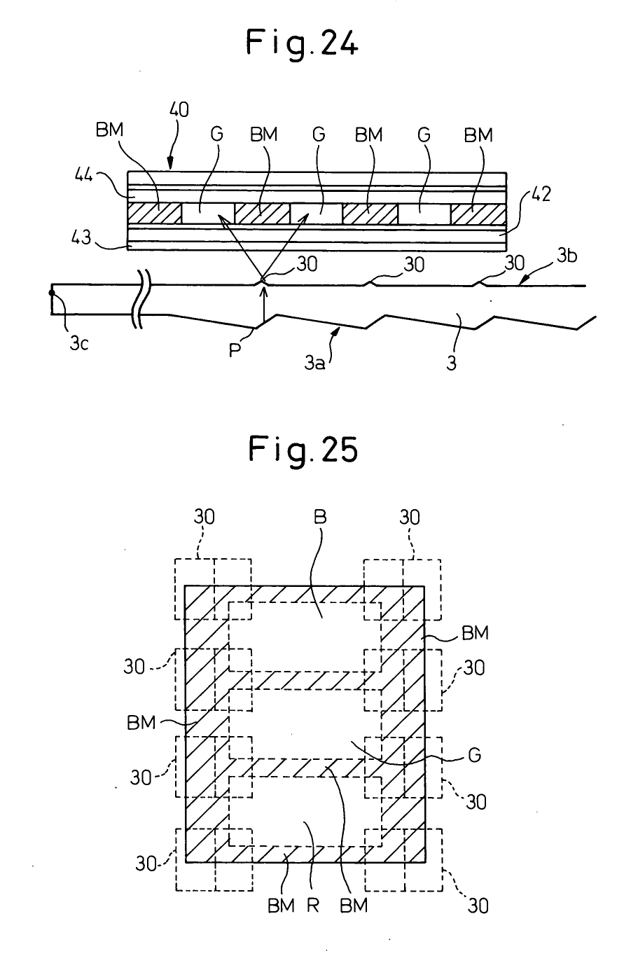

An embodying example of an illumination device in accordance with the present invention is shown schematically in FIG. 24.

In the illumination device of this embodying example, the liquid-crystal panel 40 is disposed above the prismatic light-guide plate 3, as shown in FIG. 24, and the emitted light that has been reflected by the prisms P is scattered so that the thus-emitted light (the emitted light that has been scattered) shines from oblique directions into the aperture portions of the black matrix BM (the color filters G), even if the black matrix BM is positioned directly above the scattering portions 30, by way of example. In this case, the liquid-crystal panel 40 is configured of the glass substrates 41 and 42, the polarizing plate 43, the liquid crystal 44, the color filters (G), and the black matrix BM. Note that the color filters G for green are shown in FIG. 24, but it should be obvious that red (R), green (G), and blue (B) color filters will be provided in practice.

The scattering portions 30 of the illumination device of FIG. 24 are shown in FIG. 25.

As shown in FIG. 25, the color filters G (and B and R) are disposed in the aperture portions of the black matrix BM and the shape of the scattering portions 30 is formed to be smaller than the corresponding color filters R, G, and B (the aperture portions of the black matrix BM). In other words, if the shape of the scattering portions 30 were large enough to occupy 100% of the R, G, and B color filters, an undesirable situation will occur in that the light that is emitted directly upward will be reduced if the positions of the color filters and the scattering portions 30 match.

Thus, the prismatic light-guide plate and illumination device in accordance with the present invention enables suppression of any drop in brightness at the non-light-incident end 3d due to a mismatch in the relative positions of the prisms P of the prismatic light-guide plate 3 and the aperture portions (color filters) of the black matrix BM of the liquid-crystal panel (LCD) during assembly, enabling stable performance as a liquid-crystal module and making it possible to ensure uniform brightness within the surface.

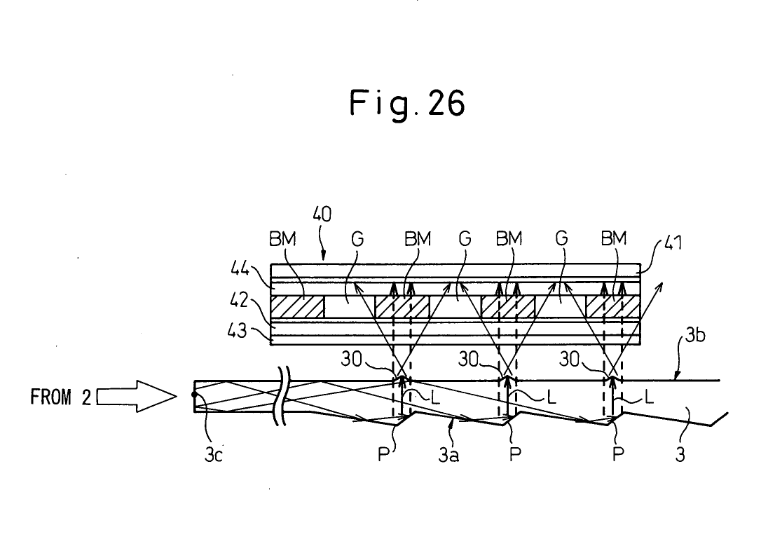

The scattering of light by a prismatic light-guide plate in accordance with the present invention is shown schematically in FIG. 26.

First of all, light from the light source (a linear beam of light from the light-conducting member 2) is generally is incident perpendicularly from the light-incident end 3c of the prismatic light-guide plate 3, is propagated in the direction of the arrows within the prismatic light-guide plate 3, and the thus-propagated light is reflected by the prisms P provided on the prismatic surface 3a and is directed towards the emission surface 3b. The emitted light L is incident on the scattering portions 30 of a convex prism shape that are provided on the emission surface 3b of the prismatic light-guide plate 3, is refracted thereby, and is emitted at angles from the emission surface 3b (the scattering portions 30). Light that is incident on the flat emission surface 3b instead of the scattering portions 30 of the convex prism shape is emitted at an angle that is close to perpendicular to the emission surface 3b.

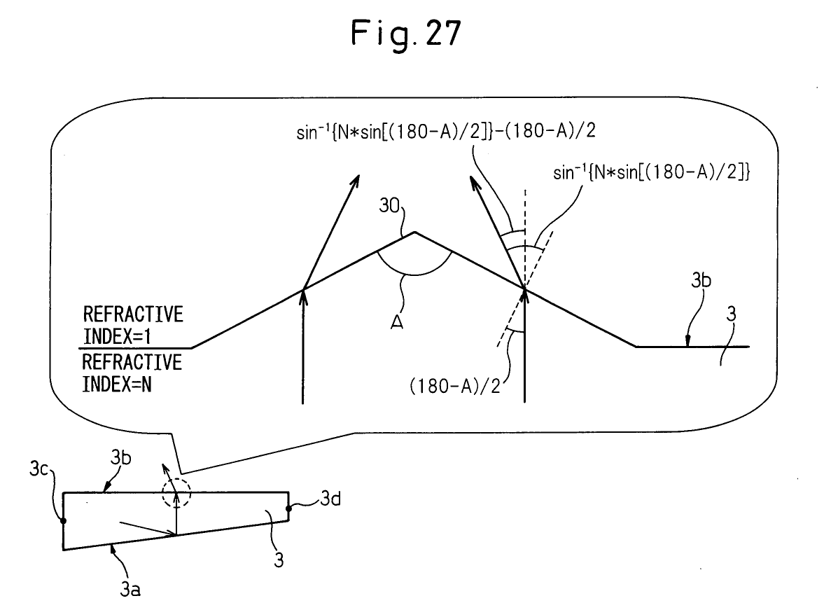

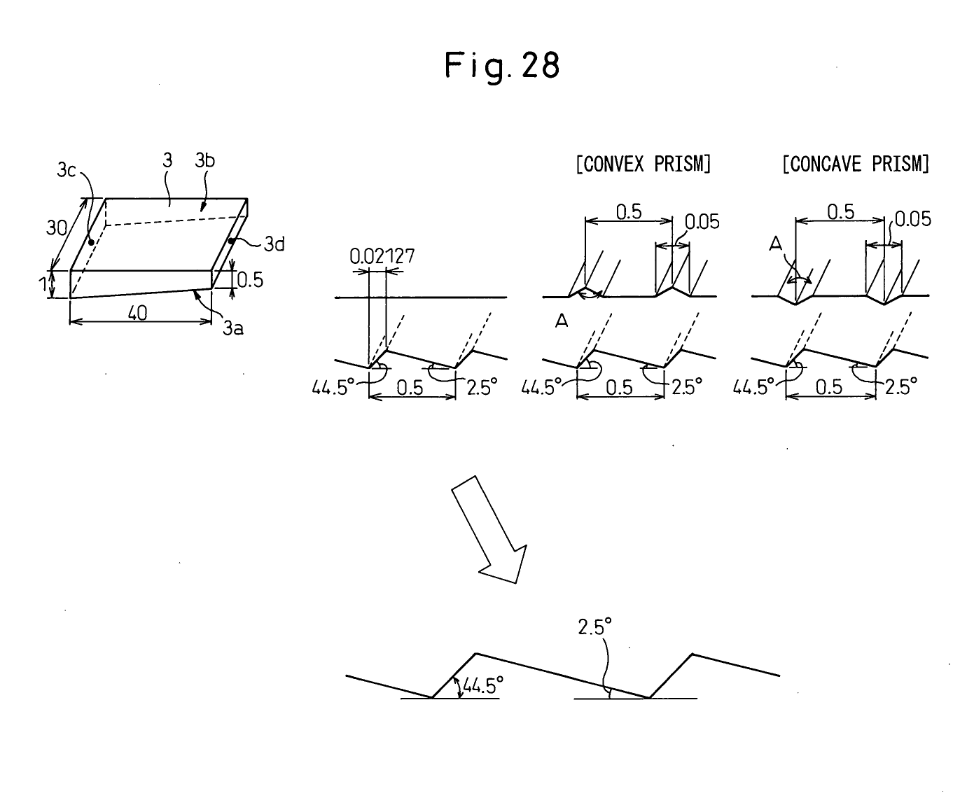

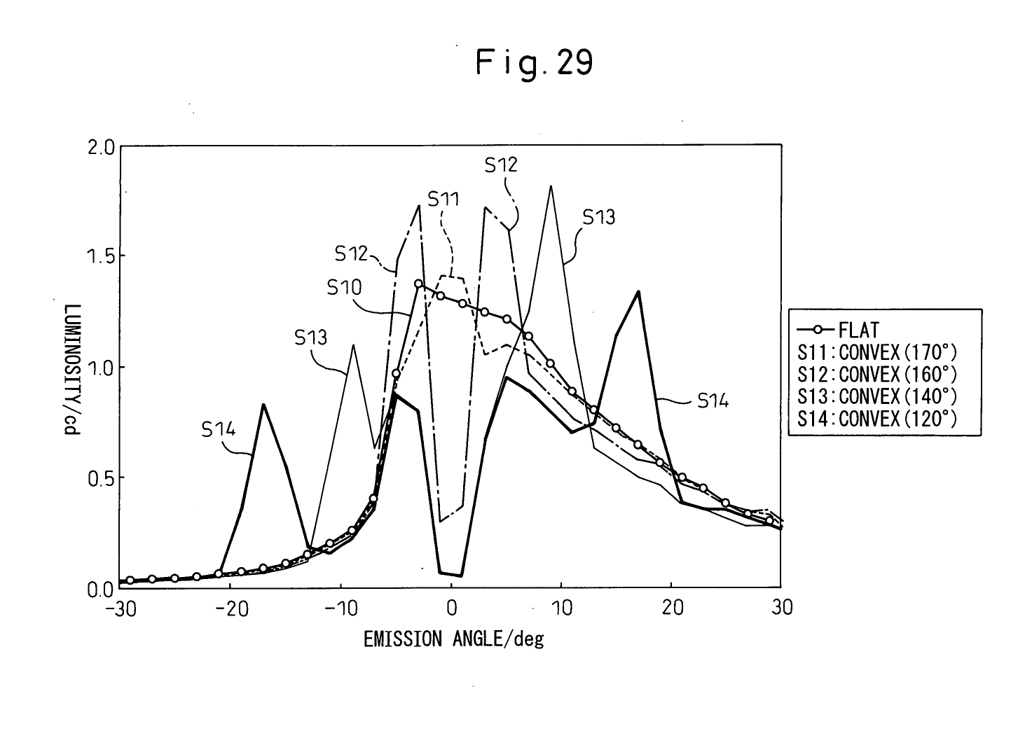

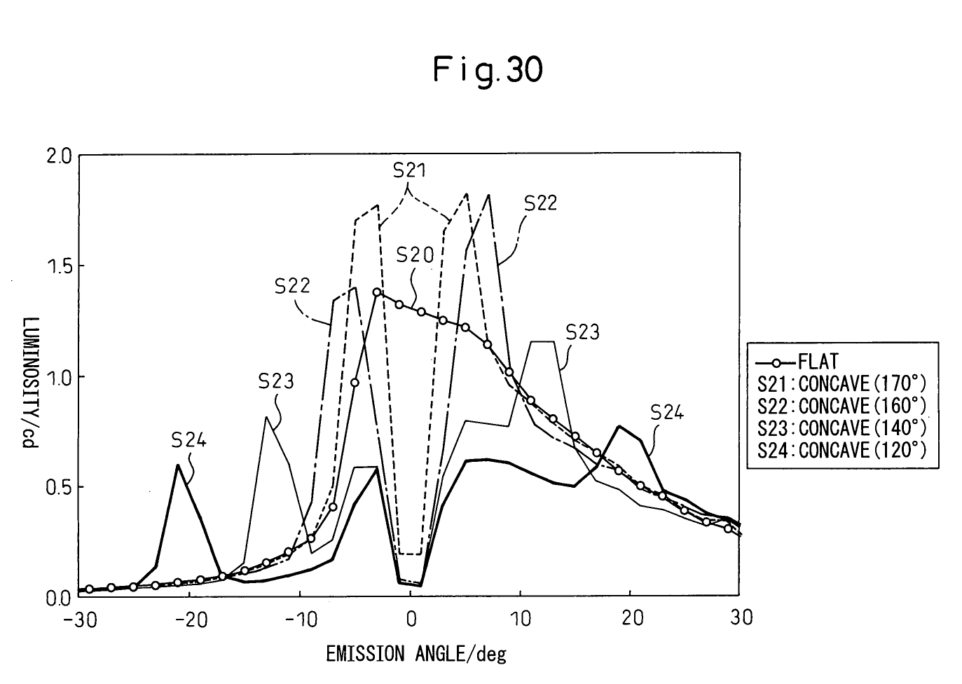

The theory of light scattering by a prismatic light-guide plate in accordance with the present invention is shown in FIG. 27, simulation models of prismatic light-guide plates in accordance with the present invention is shown in FIG. 28, and simulation results of the output of luminosity distribution and emission angle obtained by the simulation models shown in FIG. 28 are shown in FIGS. 29 and 30.

The simulations were based on the assumptions that each scattering portion (of a convex prism shape) 30 that has been formed on the emission surface 3b of the prismatic light-guide plate 3 is an isosceles triangle in section with a peak angle A, the refractive index of the prismatic light-guide plate 3 is N, and the refractive index in air is 1, as shown in FIG. 27. In addition, the simulations covered cases in which the shape of the prisms formed in the prismatic surface 3a of the prismatic light-guide plate 3 as well as the shapes of the convex prism shape and concave prismatic groove shape of the scattering portions 30 were regulated. Note that the simulations were performed with the pitch between neighboring prisms in the prismatic surface 3a of the prismatic light-guide plate 3 being 0.5 mm and the angles of each prism being 44.5° and 2.5°. In addition, the width of the prismatic light-guide plate 3 was assumed to be 30 mm, the thickness at the light-incident end 3c was 1 mm, the thickness at the non-light-incident end 3d was 0.5 mm, and the length from the light-incident end 3c to the non-light-incident end 3d was 40 mm, by way of example.

Graphs in FIGS. 29 and 30 show luminosity (cd) plotted along the vertical axis and emission angle (degrees) of the emitted light plotted along the horizontal axis. Note that the angle perpendicular to the emission surface is 0°, simulation curves S10 and S20 in FIGS. 29 and 30 relate to flat models (in which the scattering portions 30 are not provided on the emission surface 3b of the prismatic light-guide plate 3), and luminosity distribution is shown as a peak of a width of approximately 10° centered on 0° (perpendicular).

Dealing first with scattering portions of a convex prism shape, a configuration in which the peak angle of the convex prism shape of the scattering portions 30 is 160° (a simulation curve S12), by way of example, could be considered suitable for achieving moderate light scattering for emission, as shown in FIG. 29. Of course, depending on various conditions such as the characteristics of the liquid-crystal panel that is used and the dimensions of the aperture portions of the black matrix BM, a configuration with 170° (a simulation curve S11) or one with 150° (a simulation curve S13) would be preferable.

With scattering portions of a concave prismatic groove shape, a configuration in which the peak angle (the leading edge angle of the groove) of the concave prismatic groove shape of the scattering portions 30 is 170° (a simulation curve S21) or 160° (a simulation curve S22), by way of example, could be considered suitable for achieving moderate light scattering for emission, as shown in FIG. 30. Note that it should be obvious to those skilled in the art that favorable results could also be obtained with scattering portions of a concave prismatic groove shape having different angles, depending on conditions.

In the above-described manner, it has been confirmed optically that the emitted light L can be made to emerge at angles with respect to the emission surface 3b by providing the scattering portions 30 of a convex prism shape or concave prismatic groove shape on the emission surface 3b of the prismatic light-guide plate 3, or by adjusting the peak angle of convex or concave prisms. Thus the emitted light can be emitted as a broad area of light, even if something happens such as if the relative positions of the illumination device (prismatic light-guide plate) and the display device (liquid-crystal panel) shift away from the optimal positions or if only “peaky” emitted light can be obtained near the non-light-incident end of the prismatic light-guide plate. Any drop in the brightness of the light due to interference (blocking) by the black matrix can be suppressed, making it possible to provide a good-quality planar light source.

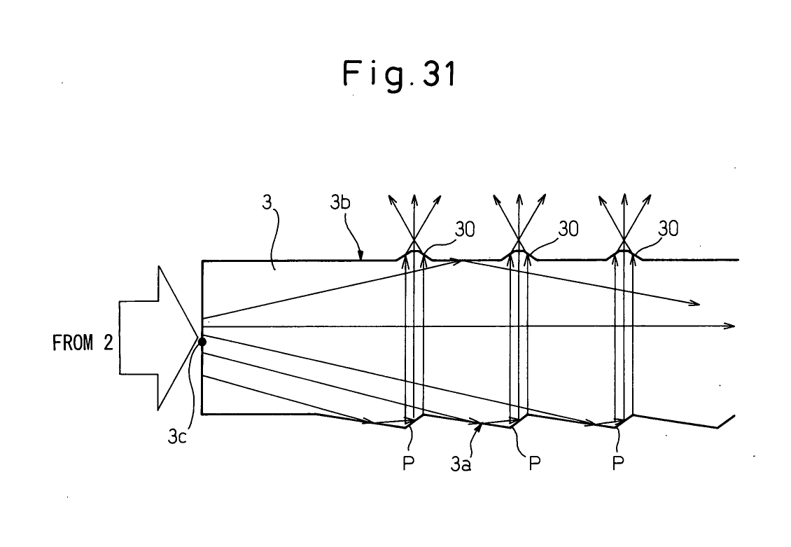

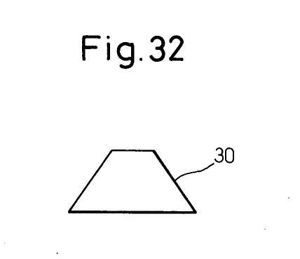

A ninth embodying example of a prismatic light-guide plate in accordance with the present invention is shown schematically in FIG. 31, and an enlargement of a scattering portion of the prismatic light-guide plate of FIG. 31 is shown in FIG. 32.

As shown in FIGS. 30 and 31, the scattering portions 30 of this ninth embodying example have a convex prism shape with a flattened ridge portion (leading edge portion), so that emitted light that has been reflected by the prisms P is not scattered thereby but is emitted unchanged. In other words, the simulation results obtained for scattering portions of a convex prism shape shown in FIG. 29 suggest that it could happen that the strength of light emitted directly above the scattering portions could be too low when the peak angle of the convex prism shape is 160° (the simulation curve S12), by way of example. In such a case, the flattening of the ridge portions of the scattering portions 30 enables a strengthening of the light emitted directly above the scattering portions. During this time, the strength of the scattered light is weakened somewhat by the scattering portions. Note that it should be obvious to those skilled in the art that similar effects can be achieved with scattering portions of a concave shape by flattening the valley portion of each concavity (the leading edge of the groove).

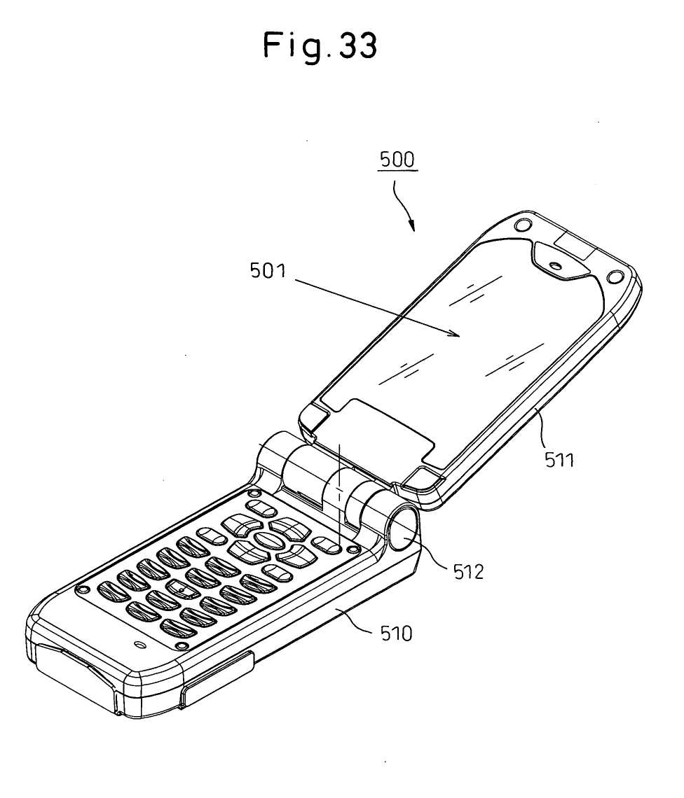

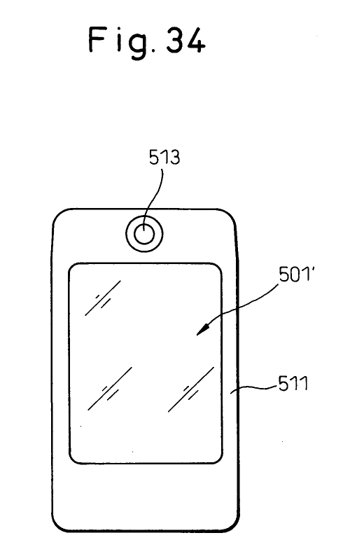

A schematic perspective view of a mobile phone that is an example of an electronic device to which the present invention can be applied is shown in FIG. 33, and the outer surface of the movable side of the mobile phone of FIG. 33 is shown schematically in FIG. 34.

An illumination device in accordance with the present invention can be employed as a display 501 for a clamshell-type mobile phone 500, as shown by way of example in FIGS. 33 and 34. In this case, the clamshell-type mobile phone 500 has a main body side 510 which is provided with operating keys such as number keys, and to which is attached by a hinge 512 a movable side 511 provided with the display 501. The display 501 is configured to display various types of information in a state in which the movable side 511 is opened, and also display an image on a display 501′ on the opposite side thereof when the movable side 511 is closed, such as when it displays an image captured by a camera (lens) 513 when the operator takes a self-portrait with that camera 513 in a state in which the movable side 511 is closed. It should be obvious to those skilled in the art that various displays such as the time can be shown on the display 501′ when the movable side 511 is closed.

In this manner, a frontlight type of planar light source unit (prismatic light-guide plate) is disposed as a backlight type of planar light source unit on each of the front and rear surfaces of a single liquid-crystal panel to form the display 501 (or 501′) of the clamshell-type mobile phone 500, as shown in FIG. 3, enabling use in which both the front and rear of a high-priced liquid-crystal panel can be observed.

In this case, both of the prismatic light-guide plates 31 and 32 of FIG. 3 could be applied to the prismatic light-guide plate 3 in accordance with the present invention, by way of example.

The present invention makes it possible to provide a prismatic light-guide plate, an illumination device, and an electronic device that enable the provision of a good-quality planar light source that has little deterioration in brightness even if the position thereof is displaced with respect to the display panel.

The present invention can also be applied to illumination devices for a variety of display devices, such as liquid-crystal panels, and, in particular, is ideal for a frontlight type of planar light source unit or a frontlight type of planar light source unit that is used as a backlit unit.

Many different embodiments of the present invention may be constructed without departing from the scope of the present invention, and it should be understood that the present invention is not limited to the specific embodiments described in this specification, except as defined in the appended claims.

What is claimed is:

1. A prismatic light-guide plate having a prismatic surface, which is provided with a plurality of prisms that reflect light that is incident from a light-incident end thereof, and an emission surface opposite to said prismatic surface, which completely reflects said light that is incident thereto to propagate the same, and which also emits emitted light that is reflected from said prisms, comprising:
scattering portions provided in a region of said emission surface that emits said emitted light at a high density, for scattering said emitted light and broadening an angle of view of light.

2. The prismatic light-guide plate as claimed in claim 1, wherein said prisms are formed in bands at a predetermined spacing on said prismatic surface.

3. The prismatic light-guide plate as claimed in claim 2, wherein said scattering portions are provided to correspond to said predetermined spacing at which said prisms are provided.

4. The prismatic light-guide plate as claimed in claim 3, wherein said scattering portions are provided in correspondence with aperture portions of a black matrix of a display unit.

5. The prismatic light-guide plate as claimed in claim 4, wherein said scattering portions are formed to include at least one aperture portion of said black matrix of said display unit.

6. The prismatic light-guide plate as claimed in claim 3, wherein each of said scattering portions comprises a convex prism shape.

7. The prismatic light-guide plate as claimed in claim 3, wherein each of said scattering portions comprises a convex cone shape.

8. The prismatic light-guide plate as claimed in claim 3, wherein each of said scattering portions comprises a concave prismatic groove shape.

9. The prismatic light-guide plate as claimed in claim 3, wherein each of said scattering portions comprises a concave cone shape.

10. The prismatic light-guide plate as claimed in claim 3, wherein each of said scattering portions comprises a flattened ridge portion.

11. The prismatic light-guide plate as claimed in claim 3, wherein each of said scattering portions comprises a shape where a light-incident end side of said prismatic light-guide plate is small and a non-light-incident end side thereof is large.

12. The prismatic light-guide plate as claimed in claim 3, wherein each of said scattering portions comprises a distribution density where a light-incident end side of said prismatic light-guide plate is low density and a non-light-incident end side thereof is high density.

13. The prismatic light-guide plate as claimed in claim 1, wherein said scattering portions are formed integrally with said prismatic light-guide plate.

14. The prismatic light-guide plate as claimed in claim 1, wherein said scattering portions are formed on a scattering portion formation sheet that is separate from said prismatic light-guide plate, and said scattering portion formation sheet is integrated with said prismatic light-guide plate by attachment to said prismatic light-guide plate.

15. An illumination device including a light source and a prismatic light-guide plate, wherein:
said prismatic light-guide plate has a prismatic surface, which is provided with a plurality of prisms that reflect light that is incident from a light-incident end thereof, and an emission surface opposite to said prismatic surface, which completely reflects said light that is incident thereto to propagate the same, and which also emits emitted light that is reflected from said prisms, wherein said prismatic light-guide plate comprises:
scattering portions provided in a region of said emission surface that emits said emitted light at a high density, for scattering said emitted light and broadening an angle of view of light.

16. The illumination device as claimed in claim 15, further comprising a light-conducting member that converts light from said light source that is a point light source into a linear beam of light, and supplies the same to said prismatic light-guide plate.

17. An electronic device comprising an illumination device including a light source and a prismatic light-guide plate, wherein:
said prismatic light-guide plate has a prismatic surface, which is provided with a plurality of prisms that reflect light that is incident from a light-incident end thereof, and an emission surface opposite to said prismatic surface, which completely reflects said light that is incident thereto to propagate the same, and which also emits emitted light that is reflected from said prisms, wherein said prismatic light-guide plate comprises:
scattering portions provided in a region of said emission surface that emits said emitted light at a high density, for scattering said emitted light and broadening an angle of view of light.

18. The electronic device as claimed in claim 17, wherein:
said illumination device is provided with a first illumination device provided on one display surface of said display panel and a second illumination device provided on another display surface of said display panel; and
an image on said one display surface is displayed by light emitted from said second illumination device and also an image on said other display surface is displayed by light emitted from said first illumination device.

19. The electronic device as claimed in claim 18, wherein said display panel is a transmissive liquid-crystal display panel.

20. The electronic device as claimed in claim 17, wherein said electronic device is a clamshell-type mobile phone and the configuration is such that images displayed on said display panel are displayed by switching said first and second illumination devices for display on either the front or back of a movable side portion.
